(19) United States
(12) Patent Application Publication
(10) Pub. No.: US 2023/0190571 A1
(43) Pub. Date: Jun. 22, 2023

(54) AIR PUMP SYSTEM FOR MASSAGER

(71) Applicant: TECHNO TAKATSUKI CO., LTD., Osaka (JP)

(72) Inventors: Hideki ISHII, Osaka (JP); Kazuma SHIMIZU, Osaka (JP)

(21) Appl. No.: 18/065,623

(22) Filed: Dec. 14, 2022

(30) Foreign Application Priority Data
Dec. 20, 2021 (JP) 2021-206348

(51) Int. Cl. A61H 9/00

(52) U.S. Cl. CPC A61H 9/0078; A61H 2201/1238; A61H 2201/5056; A61H 2201/0107; A61H 2201/1409

(57) ABSTRACT

An air pump system includes a pump, a main valve device, and a distribution valve device connected between the pump and the main valve device, that includes a first portion forming a first chamber and a second portion forming a second chamber. The first portion includes a first free port to fluidly couple the first chamber with the pump, a first connection port to fluidly couple the first chamber with the main valve device, a second connection port to fluidly couple the first chamber with an outside of the distribution valve device, and a first valve switch. The second portion includes a second free port to fluidly couple the second chamber with the pump, a third connection port to fluidly couple the second chamber with the main valve device, a fourth connection port to fluidly couple the second chamber with the outside, and a second valve switch.

### CROSS-REFERENCE TO RELATED APPLICATION

This application is based upon and claims the benefit of priority from Japanese Patent Application No. 2021-206348, filed on Dec. 20, 2021, the entire contents of which are incorporated herein by reference.

### BACKGROUND

Air massagers may include airbags in which compressed air is supplied to and drawn from. U.S. Pat. No. 6,785,224 describes a compression system for use with a compression garment including expandable bladders. U.S. Pat. No. 6,785,224 describes an inlet port of a bi-directional valve controlling opening and closing of expandable bladders and an inlet port of a vent valve that are both connected to the same manifold.

### SUMMARY

In the pressure system disclosed in U.S. Pat. No. 6,785,224, gas in an expandable bladder is exhausted (or released) through the vent valve. During an operation to force a decrease of an internal pressure of the expandable bladder, it may be difficult to effectively release the gas therefrom, depending on the performance of the vent valve selected.

An example air supply/exhaust system (or air pump system) for an air massager includes an air pump, an air distribution valve unit (or air distribution valve device) connected to the air pump, and a main valve unit (or main valve device) including solenoid valve units (or solenoid valve devices) connected to the air distribution valve unit.

The example air distribution valve unit includes a first portion including a first free port connected to a supply port of the air pump, a first connection port connected to the main valve unit, a second connection port connected to an outside, and a first switching mechanism (or first switch) configured to control opening and closing of the first connection port and opening and closing of the second connection port, and a second portion including a second free port connected to an inlet port (or suction port) of the air pump, a third connection port connected to the main valve unit, a fourth connection port connected to the outside, and a second switching mechanism (or second switch) configured to control opening and closing of the third connection port and opening and closing of the fourth connection port.

According to the air supply/exhaust system for an air massager, the main valve unit is connected to both the supply port and the inlet port of an air pump through the air distribution valve unit. Therefore, by using the air distribution valve unit, not only gas supply to the main valve unit by the air pump but also gas suction from the main valve unit by the air pump can be performed. Thus, according to the air supply/exhaust system for an air massager, the internal pressure of the internal space of the main valve unit or the like can be more readily forced to decrease by controlling the air distribution valve unit.

Each of the solenoid valve units may include a chamber, the first connection port and the fourth connection port may be opened and the second connection port and the third connection port may be closed when the air pump supplies gas, the second connection port and the third connection port may be opened and the first connection port and the fourth connection port may be closed when the air pump is suspended and the internal pressure of at least one chamber is adjusted, and the first connection port and the second connection port may be opened and the third connection port and the fourth connection port may be closed when the air pump is suspended and the internal pressure of each chamber is decompressed. In this case, various pressure control may be performed on the chamber using the air distribution valve unit. Since the gas exhaust port is not limited to one of the second connection port and the fourth connection port, deterioration of one of the first switching mechanism and the second switching mechanism is less likely to be accelerated.

The first switching mechanism may include a first two way valve configured to control opening and closing of the first connection port and a second two way valve configured to control opening and closing of the second connection port, and the second switching mechanism may include a third two way valve configured to control opening and closing of the third connection port and a fourth two way valve configured to control opening and closing of the fourth connection port. In this case, the structure of the air distribution valve unit can be simplified.

The air distribution valve unit and each of the solenoid valve units may have the same configuration. In this case, since the number of common components in the air supply/exhaust system is increased, cost can be reduced and maintenance can be improved.

The second portion may further include a fifth connection port connected to the outside, the first switching mechanism may include a first three way valve and a second three way valve connected in series to each other, the second switching mechanism may include a third three way valve connected to the second free port, the third connection port, and the fourth connection port, the first three way valve may be connected to the first free port, the second connection port, and the second three way valve, and the second three way valve may be connected to the first connection port, the fifth connection port, and the first three way valve. In this case, the number of valves included in the air distribution valve unit can be reduced compared to a case where a two way valve is used.

Each of the solenoid valve units may have a chamber, the first connection port and the fourth connection port may be opened, and the second connection port, the third connection port and the fifth connection port may be closed when the air pump supplies gas, the second connection port and the third connection port may be opened, and the first connection port, the fourth connection port and the fifth connection port may be closed when the air pump sucks gas, and the fifth connection port is opened, and the first connection port, the second connection port, the third connection port and the fourth connection port may be closed when the air pump is in a suspended state and an internal pressure of at least one of the chambers is adjusted. In this case, since the gas exhaust port is not limited to one of the second connection port and the fifth connection port, deterioration of one of the first three way valve and the second three way valve is less likely to be accelerated.

An example air massager is disclosed herein, includes the air supply/exhaust system described herein and an example massage device connected to a main valve unit of the air supply/exhaust system, to more readily achieve a forced internal decompression with respect to the internal space of the massage device or the like by control of the air distribution valve unit.

### BRIEF DESCRIPTION OF THE DRAWINGS

FIG. 1 is a schematic diagram showing an example air massager.

FIG. 2 is a perspective view of a massage device.

FIG. 3 is a schematic perspective view of an inside of the air supply/exhaust system.

FIG. 4A is a perspective view of an air distribution valve unit, and FIG. 4B is a front view of the air distribution valve unit.

FIG. 5A is a schematic cross-sectional view taken along line Va-Va of FIG. 4B, and FIG. 5B is a schematic cross-sectional view taken along line Vb-Vb of FIG. 4B.

FIG. 6 is a circuit diagram of an air distribution valve unit.

FIG. 7 is a circuit diagram of a part of the massage device, an air pump, an air distribution valve unit, and one solenoid valve unit.

FIG. 8A is a bottom view of the air supply/exhaust system, and FIG. 8B is a schematic view in which a portion of the housing is removed from the air supply/exhaust system of FIG. 8A.

FIGS. 9A and 9B are circuit diagrams of an air pump and an air distribution valve unit.

FIGS. 10A and 10B are circuit diagrams of an air pump and an air distribution valve unit.

FIG. 11 is a diagram of an example kneading pattern using a massage device.

FIG. 12 is a circuit diagram of an air distribution valve unit and an air pump according to another example.

FIG. 13 is a circuit diagram of an air pump and an air distribution valve unit.

FIG. 14 is a circuit diagram of an air pump and an air distribution valve unit.

FIG. 15 is a circuit diagram of an air pump and an air distribution valve unit.

### DETAILED DESCRIPTION

Hereinafter, examples will be described with reference to the accompanying drawings. In the following description, the same elements or elements having the same functions are denoted by the same reference numerals, and redundant description is omitted.

An example air massager is configured to massage a body of a subject using high-pressure gas. The air massager is used to stimulate the body of the subject, for example, to “massage” the body of the subject for the purpose of improving the physical condition of the subject, such as improving the stagnation of veins and lymph of the subject and improving the flow of the veins and lymph. The term “high-pressure gas” may refer to a gas having an atmospheric pressure higher than the atmospheric pressure. In some examples, the gas is air from the viewpoint of convenience. In other examples, the gas may be an inert gas such as He (helium) and N₂ (nitride), and other gases such as O₂ (oxide).

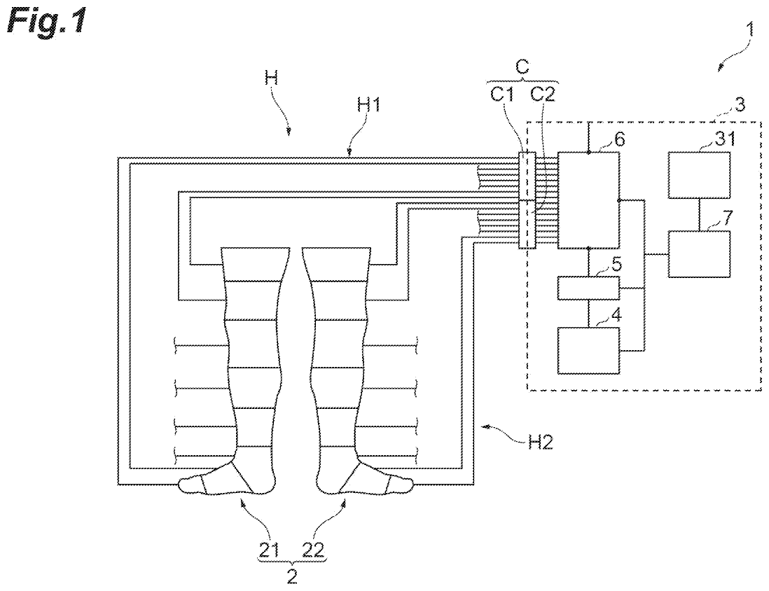

As shown in FIG. 1, an example air massager 1 includes a massage device (or inflatable device) 2 and an air supply/exhaust system (or air pump system) 3 connected to the massage device 2. The “connection” in some examples is not limited to a simple physical connection. For example, when a fluid such as a gas or a liquid flows between two devices through an intermediate member such as a hose, a tube, or a tank, the two devices are considered to be connected (fluidly connected or fluidly coupled) to each other.

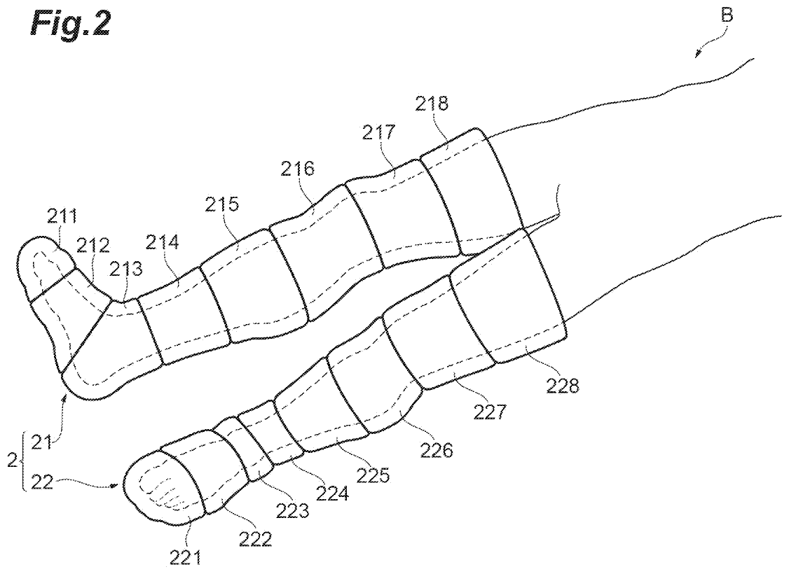

The massage device 2 is a device for massaging the body of a subject. The massage device 2 is connected to the air supply/exhaust system 3 (air pump system or air supply/exhaust system for an air massager) through a hose H and a connector C as shown in FIG. 1. The massage device 2 expands by being supplied with high-pressure gas from the air supply/exhaust system 3, and contracts by being exhausted with high-pressure gas through the air supply/exhaust system 3. The massage device 2 compresses the body by expanding and releases the compression of the body by contracting. The massage device 2 massages the body of the subject by repeating compression and decompression of the body. In some examples, as shown in FIG. 2, the massage device 2 is configured to be worn so as to surround a part of the body B of the subject, compress the body B from the periphery of the body B, and then release the compression. The massage device 2 includes a first massage device 21 worn so as to surround the right foot and a second massage device 22 worn so as to surround the left foot.

The first and second massage devices 21, 22 are connected to the air supply/exhaust system 3 through first and second hoses H1, H2 and first and second connectors C1, C2, respectively. However, the massage device 2 is not limited to the boot shape divided into two as shown in FIG. 2 as long as it has a shape corresponding to the body B to be massaged. For example, it may have a boot shape on only one of the left and right sides, may have a trouser shape integrated for both left and right feet to massage the entire lower half of the body B, may have a shorts shape to massage the periphery of the waist of the body B, or may have a shirt shape to massage the entire upper half of the body B.

As shown in FIGS. 1 and 2, the massage device 2 includes bladders (or airbags) 211 to 218 and 221 to 228 that expand by receiving high-pressure gas and contract by discharging the high-pressure gas. The massage device 2 is fluidly connected to the air supply/exhaust system 3 by fluidly connecting the bladders 211 to 218 and 221 to 228 to the air supply/exhaust system 3. Also, the massage device 2 is configured to expand and contract as the bladders 211 to 218 and 221 to 228 expand and contract. In some examples, the massage device 2 includes bladders 211 to 218 and 221 to 228 (in the illustrated example, 16 bladders). The massage device 2 includes the bladders 211 to 218 and 221 to 228, so that the massage device 2 can expand and contract at each corresponding location. However, the massage device 2 may be configured to expand to compress the body B and contract to release the compression of the body B, and may include at least one bladder for that purpose.

As shown in FIG. 2, each of the bladders 211 to 218 and 221 to 228 is provided so as to correspond to each part of the body B to be massaged. In some examples, as shown in FIG. 2, the bladders 211 to 218 for the first massage device 21 and the bladders 221 to 228 for the second massage device 22 are arranged in order, respectively. The bladders 211 to 218 are arranged in order from the bladder 211 provided at the site corresponding to the toe toward the bladder 218 provided at the site corresponding to the upper thigh. Similarly, the bladders 221 to 228 are arranged in order from the bladder 221 provided at the site corresponding to the toe toward the bladder 228 provided at the site corresponding to the upper thigh. In the massage device 2, the arrangement and number of bladders can be appropriately set according to the region of the body B to be massaged and according to the control mode of the massage to be performed.

Each of the bladders 211 to 218 and 221 to 228 is formed as a substantially cylindrical bag body so as to surround a part of the body B to be massaged. Each of the bladders 211 to 218 and 221 to 228 is sized to expand to compress a corresponding part of the body B and contract to release compression of the corresponding part of the body B. The shapes and sizes of the bladders 211 to 218 and 221 to 228 can be appropriately determined in accordance with the region of the body B, respectively. In addition, the bladders 211 to 218 and 221 to 228 are not particularly limited as long as they have airtightness for storing high-pressure gas and can be deformed by receiving and discharging the high-pressure gas. The bladders 211 to 218 and 221 to 228 are formed of, for example, a resin material.

The air supply/exhaust system 3 supplies high-pressure gas to the at least one of the bladders 211 to 218 and 221 to 228 and exhausts high-pressure gas from the at least one of the bladders 211 to 218 and 221 to 228. As shown in FIG. 1, the air supply/exhaust system 3 includes an air pump 4, an air distribution valve unit (air distribution valve device) 5 connected to the air pump 4, a main valve unit (main valve device) 6 connected to the air distribution valve unit 5, and a controller 7 for controlling the air pump 4, the air distribution valve unit 5, and the main valve unit 6. The main valve unit 6 is connected to the first massage device 21 and the second massage device 22. The air supply/exhaust system 3 may be provided with, for example, a display unit that displays an operation mode (a kneading pattern described later, or the like).

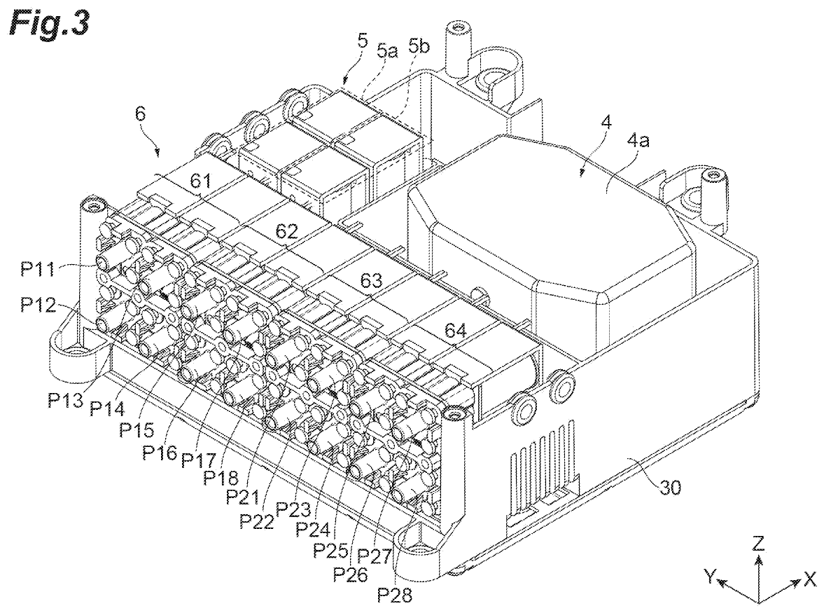

FIG. 3 is a schematic perspective view showing an inside of the air supply/exhaust system. As shown in FIG. 3, the air pump 4, the air distribution valve unit 5, and the main valve unit 6 are mounted on the housing 30. The housing 30 is combined with a lid to function as a box that protects the inside of the air supply/exhaust system 3.

The air pump 4 is a device that supplies high-pressure gas to the air distribution valve unit 5 and sucks gas from the air distribution valve unit 5. The air pump 4 may include, for example, a pump that sends out high-pressure gas, a cylinder from which high-pressure gas is ejected by opening a valve, and the like. In a plan view, the air pump 4 is aligned with the main valve unit 6 along a direction X, and is aligned with the air distribution valve unit 5 along a direction Y orthogonal to the direction X. Hereinafter, the direction X may be referred to as a front-rear direction, and the direction Y may be referred to as a left-right direction. In addition, a direction Z orthogonal to the directions X and Y may be referred to as an up-down direction.

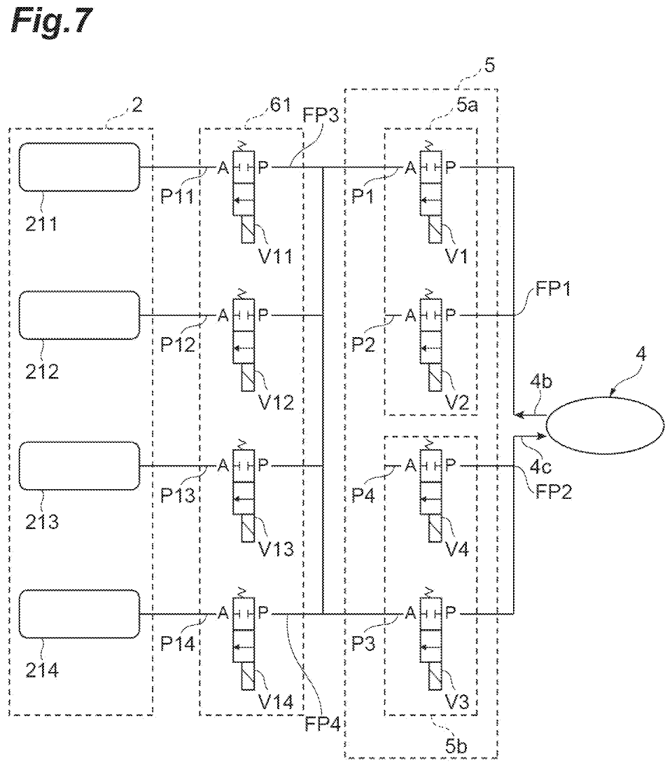

The air pump 4 includes a main body 4a, a supply port 4b (cf. FIG. 7) that supplies gas from the main body 4a to an outside (environing air), and an inlet port 4c (or suction port) (cf. FIG. 7) that draws in gas from the outside into the main body 4a. Each of the supply port 4b and the inlet port 4c is connected to an air distribution valve unit 5. For example, the air pump 4 supplies gas to the main valve unit 6 through the supply port 4b and the air distribution valve unit 5 (gas supply operation). At this time, the air pump 4 sucks in gas from the outside through the inlet port 4c and the air distribution valve unit 5. Further, the air pump 4 sucks gas from the main valve unit 6 through the inlet port 4c and the air distribution valve unit 5. At this time, the air pump 4 supplies (exhausts) gas to the outside through the supply port 4b and the air distribution valve unit 5 (forced decompression operation).

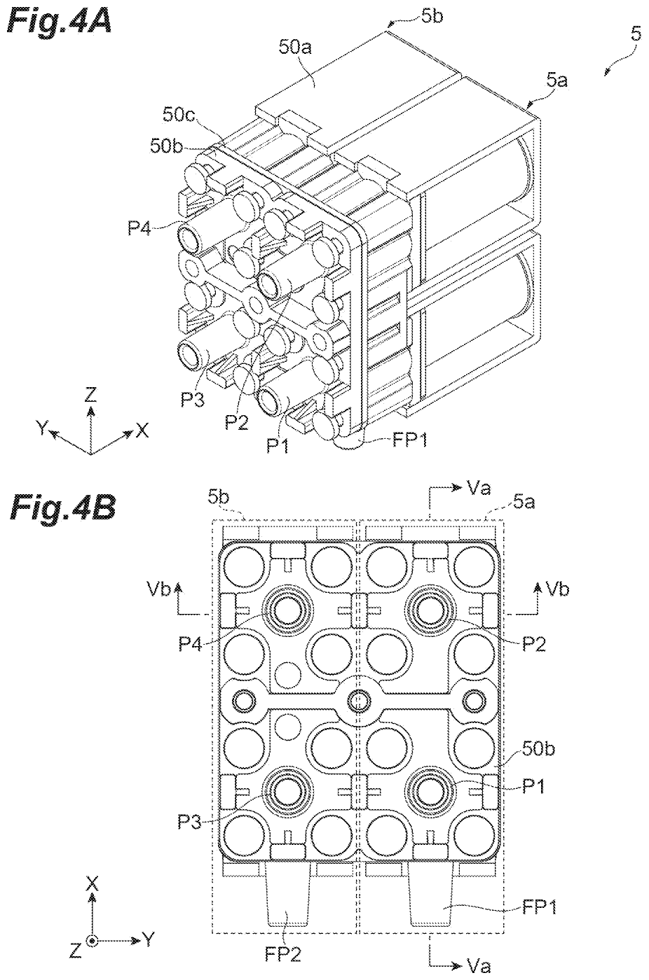

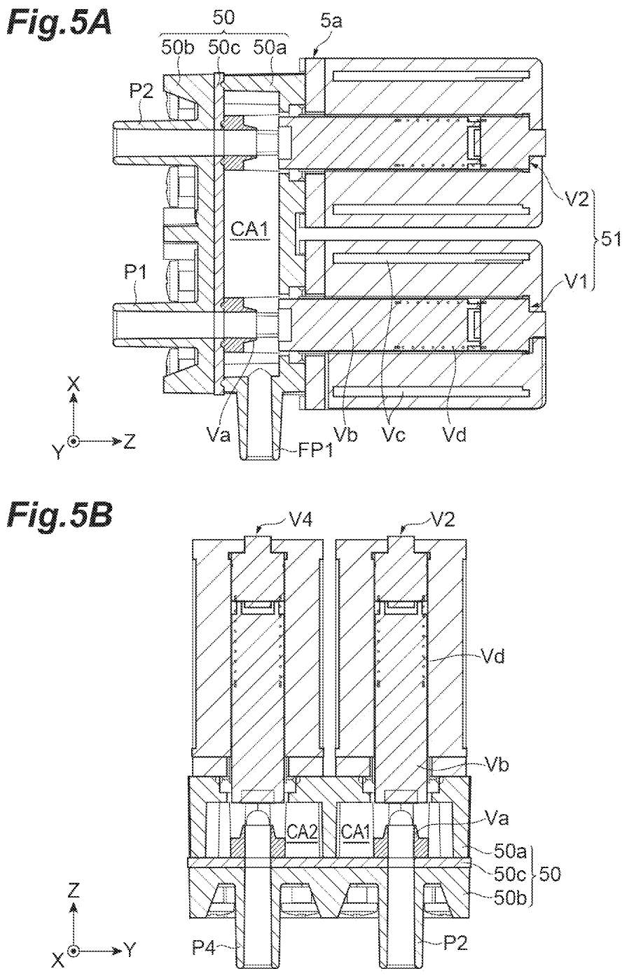

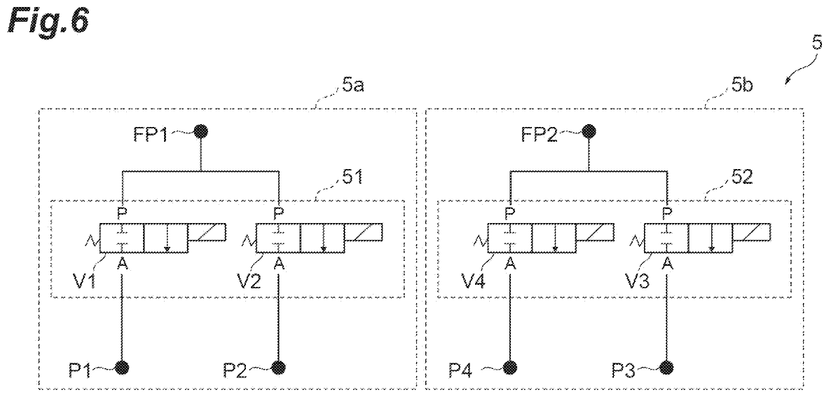

FIG. 4A is a perspective view showing the air distribution valve unit, and FIG. 4B is a front view showing the air distribution valve unit. FIG. 5A is a schematic cross-sectional view taken along line Va-Va of FIG. 4B, and FIG. 5B is a schematic cross-sectional view taken along line Vb-Vb of FIG. 4B. FIG. 6 shows a circuit diagram of an air distribution valve unit. The air distribution valve unit 5 shown in FIGS. 3, 4A, 4B, 5A, 5B and FIG. 6 is a device for controlling the supply of high-pressure gas to the main valve unit 6 and the gas suction from the main valve unit 6. The air distribution valve unit 5 is, for example, a device that switches a flow path between the air pump 4 and the main valve unit 6 to a flow path through which gas is supplied from the air pump 4 to the main valve unit 6, a flow path through which gas is sucked from the main valve unit 6 to the air pump 4, or the like. The air distribution valve unit 5 is located downstream of the air pump 4 and upstream of the main valve unit 6.

The air distribution valve unit 5 includes a main body 50, a first free port FP1, a second free port FP2, a first connection port P1, a second connection port P2, a third connection port P3, a fourth connection port P4, a first switching mechanism (first switch) 51, and a second switching mechanism (second switch) 52.

The main body 50 includes a first member 50a, a second member 50b, and a sealing member 50c located between the first member 50a and the second member 50b. The first member 50a is a main part of the main body 50, and includes the first free port FP1, the second free port FP2, the first switching mechanism 51, and the second switching mechanism 52. A recess is provided in a portion of the first member 50a that faces the second member 50b, and the first free port FP1 and the second free port FP2 communicate with the recess. The second member 50b is a cover portion of the main body 50, and includes the first connection port P1, the second connection port P2, the third connection port P3, and the fourth connection port P4. The sealing member 50c is a member that provides airtightness between the first member 50a and the second member 50b.

The first member 50a, the second member 50b, and the sealing member 50c are fixed to each other by, for example, a known fixing means such as fitting, screwing, or the like. The first member 50a and the second member 50b may have rigidity such that deformation can be suppressed with respect to the pressing force by the high-pressure gas and the pressing force accompanying opening and closing of the port by the solenoid valve. Each of the first member 50a and the second member 50b is formed of, for example, a resin material, a ceramic material, a metallic material, or the like. The sealing member 50c is, for example, an annular resin member. The resin member may have elasticity, for example.

The air distribution valve unit 5 includes a first portion 5a and a second portion 5b arranged along the direction Y. The first portion 5a and the second portion 5b are independent of each other. That is, the internal space of the first portion 5a and the internal space of the second portion 5b are partitioned from each other. Therefore, the gas flowing into the first portion 5a does not directly flow into the second portion 5b. In other words, in the air distribution valve unit 5, the gas in the first portion 5a and the gas in the second portion 5b are not mixed with each other.

The first portion 5a includes a chamber CA1, the first free port FP1 connected to the supply port 4b of the air pump 4, the first connection port P1 connected to the main valve unit 6, the second connection port P2 connected to the outside, and the first switching mechanism 51 for controlling opening and closing of the first connection port P1 and opening and closing of the second connection port P2. The second portion 5b includes a chamber CA2 different from the chamber CA1, the second free port FP2 connected to the inlet port 4c of the air pump 4, the third connection port P3 connected to the main valve unit 6, the fourth connection port P4 connected to the outside, and the second switching mechanism 52 for controlling opening and closing of the third connection port P3 and opening and closing of the fourth connection port P4. The outside of the air distribution valve unit 5 is, for example, an outside air of the air supply/exhaust system 3.

As shown in the FIG. 5A, the chamber CA1 is an internal space provided in the first portion 5A, and communicates with the first free port FP1, the first connection port P1, and the second connection port P2. The gas flowing into the chamber CA1 is supplied from the air pump 4 through the first free port FP1 and is supplied to the main valve unit 6 through the first connection port P1. Alternatively, the gas is exhausted to the outside through a second connection port P2.

The first free port FP1 is a port extending toward the rear side of the air supply/exhaust system 3 in the direction X. The first free port FP1 is connected to the air pump 4 through, for example, a tube, a tank, or the like. Each of the first connection port P1 and the second connection port P2 is a port that extends toward the bottom side of the air supply/exhaust system 3 in the direction Z.

As shown in the FIG. 5B, the chamber CA2 is an internal space provided in the second portion 5b, and communicates with the second free port FP2, the third connection port P3, and the fourth connection port P4. The chamber CA2 is independent of the chamber CA1 and has substantially the same shape as the chamber CA1. The gas flowing into the chamber CA2 is sucked into the air pump 4 through the second free port FP2 or exhausted to the outside through the fourth connection port P4.

The second free port FP2 is a port that extends toward the rear side of the air supply/exhaust system 3 in the direction X. The second free port FP2 is connected to the air pump 4 through, for example, a tube or a tank. Each of the third connection port P3 and the fourth connection port P4 is a port that extends toward the bottom side of the air supply/exhaust system 3 in the direction Z.

The first switching mechanism 51 is a mechanism for switching the flow path of gas flowing into the chamber CA1 of the first portion 5a, and includes a first solenoid valve P1 for opening and closing the first connection port V1 and a second solenoid valve P2 for opening and closing the second connection port V2. The first solenoid valve V1 is a two way valve that opens and closes the first connection port P1 by being driven by electricity. The second solenoid valve V2 is a two way valve that opens and closes the second connection port P2 by being driven by electricity. In some examples, the first solenoid valve V1 and the second solenoid valve V2 have the same structure each other.

The second switching mechanism 52 is a mechanism for switching the flow path of the gas flowing into the chamber CA2 of the second portion 5b. As shown in FIG. 6, the second switching mechanism 52 includes a third solenoid valve V3 for opening and closing the third connection port P3 and a fourth solenoid valve V4 for opening and closing the fourth connection port P4. In some examples, each of the third solenoid valve V3 and the fourth solenoid valve V4 is a two way valve having the same structure as the first solenoid valve V1. Therefore, the structure of the first solenoid valve V1 will be described below, and the description of the second solenoid valve V2, the third solenoid valve V3, and the fourth solenoid valve V4 will be omitted.

The first solenoid valve V1 includes a valve seat Va, a valve element Vb, an electromagnet Vc, and an energization element Vd. The valve seat Va is adjacent to the first connection port P1 to be opened and closed, and is a portion on which the valve element Vb is provided to be able to abut. The valve seat Va is formed in such a manner that the first connection port P1 is closed when the valve element Vb is brought into contact therewith. The valve seat Va has, for example, a substantially cylindrical trapezoidal shape extending toward the valve element Vb.

The valve element Vb is a portion that opens and closes the first connection port P1 in cooperation with the valve seat Va, and is a rod-shaped portion extending along the direction Z. The valve element Vb moves, for example, between a position where the valve element Vb abuts on the valve seat Va and a position where the valve seat Va is exposed. The valve element Vb is movable along the direction Z by the electromagnetic force from the electromagnet Vc and the biasing force from the energization element Vd. The valve element Vb includes a magnetic material such as iron so as to be driven by the electromagnetic force from the electromagnet Vc. A distal end portion of the valve element Vb that abuts on the valve seat Va may be formed of an elastic body such as rubber. In this case, when the distal end portion of the valve element Vb comes into contact with the valve seat Va, the distal end portion of the valve element Vb can deform following the shape of the valve seat Va. Accordingly, the valve seat Va and the valve element Vb come into close contact with each other.

The electromagnet Vc applies an electromagnetic force to the valve element Vb by being supplied with electric power. In some examples, the electromagnet Vc is configured to be capable of applying an electromagnetic force, which energizes the valve element Vb in a direction away from the valve seat Va when power is supplied, to the valve element Vb. However, the electromagnet Vc may be configured to be capable of applying an electromagnetic force, that energizes the valve element Vb toward the valve seat Va, to the valve element Vb when powered. Although the electromagnet Vc is not particularly limited, a cylindrical solenoid coil in which the valve element Vb is accommodated may be adopted from the viewpoint of the simplicity of the structure.

The energization element Vd energizes the valve element Vb in a predetermined direction in order to maintain the open state or the closed state of the first connection port P1. The energization element Vd energizes the valve element Vb toward the valve seat Va, for example, to maintain the closed state. In this case, the first solenoid valve V1 is a normally closed valve that is maintained in a closed state when power is not supplied. The energization element Vd may bias the valve element Vb in a direction away from the valve seat Va to maintain the open state. In this case, the first solenoid valve V1 is a normally open valve that is maintained in an open state when power is not supplied. The energization element Vd is not particularly limited as long as it can energize the valve element Vb in a predetermined direction, and may be a known spring or the like.

Referring back to FIG. 3, the main valve unit 6 is a device that switches between a flow path for supplying high-pressure gas to each of the bladders 211 to 218 and 221 to 228 of the massage device 2 and a flow path for exhausting high-pressure gas from each of the bladders 211 to 218 and 221 to 228 of the massage device 2 in conjunction with the air distribution valve unit 5. In some example, the main valve unit 6 includes four solenoid valve units (solenoid valve devices) 61 to 64. The solenoid valve units 61 to 64 are devices arranged in order along the direction Y, and respectively include at least one solenoid valve. For example, the solenoid valve units (solenoid valve devices) 61 to 64 may be modular devices that form the main valve unit (main valve device) 6.

In some examples, each of the solenoid valve units 61 to 64 has the same structure as the air distribution valve unit 5. Therefore, each of the solenoid valve units 61 to 64 includes two chambers (a first chamber and a second chamber), two free ports, four connection ports, and four solenoid valves. In each of the solenoid valve units 61 to 64, each free port is a port extending toward the bottom side of the housing 30 in the direction Z, and each connection port is a port extending toward the front side of the housing 30 in the direction X. Therefore, in the direction X, the respective connection ports, and the first free port FP1 and the second free port FP2 of the air distribution valve unit 5 extend in opposite directions to each other. Accordingly, the solenoid valve units (solenoid valve device) 61 to 64, as well as air distribution valve unit (air distribution valve device) 5 may be provided by identical modular devices, so as to be interchangeable. A single modular device may form the air distribution valve unit (air distribution valve device) 5 or the main valve unit (main valve device) 6, according to examples. In some examples, two or more modular devices may be combined to form the main valve unit (main valve device) 6. The modular device may be coupled between a gas supply device and gas consumption device. For example, in a case where the modular device is set as the air distribution valve unit (air distribution valve device) 5, the modular device is coupled between the air pump 4 as a gas supply device, and the main valve unit (main valve device) 6 as the gas consumption device. In a case where the modular device is set as one of the solenoid valve units (solenoid valve device) 61 to 64, the modular device is coupled between the main valve unit (main valve device) 6 as a gas supply device, and the massage device 2 as a gas consumption device.

FIG. 7 is a circuit diagram of a part of the massage device, an air pump, an air distribution valve unit, and one solenoid valve unit. As shown in FIG. 7, both the free port FP3 and the free port FP4 included in the solenoid valve unit 61 are connected to the first connection port P1 and the third connection port P3 of the air distribution valve unit 5, respectively. The connection ports P11 to P14 included in the solenoid valve unit 61 are connected to the bladders 211 to 214, respectively. Gas supply to bladders 211 to 214 or gas exhaust from the bladders 211 to 214 is controlled by the solenoid valves V11 to V14 included in the solenoid valve unit 61. Further, for example, connection ports P15 to P18 included in the solenoid valve unit 62 are connected to the bladders 215 to 218, respectively (cf FIG. 3). Similarly, connection ports P21 to P24 included in the solenoid valve unit 63 are connected to the bladders 221 to 224, respectively, and connection ports P25 to P28 included in the solenoid valve unit 64 are connected to the bladders 225 to 228, respectively (cf FIG. 3). Opening and closing of each of the connection ports P11 to P18 and P21 to P28 is controlled by a corresponding solenoid valve.

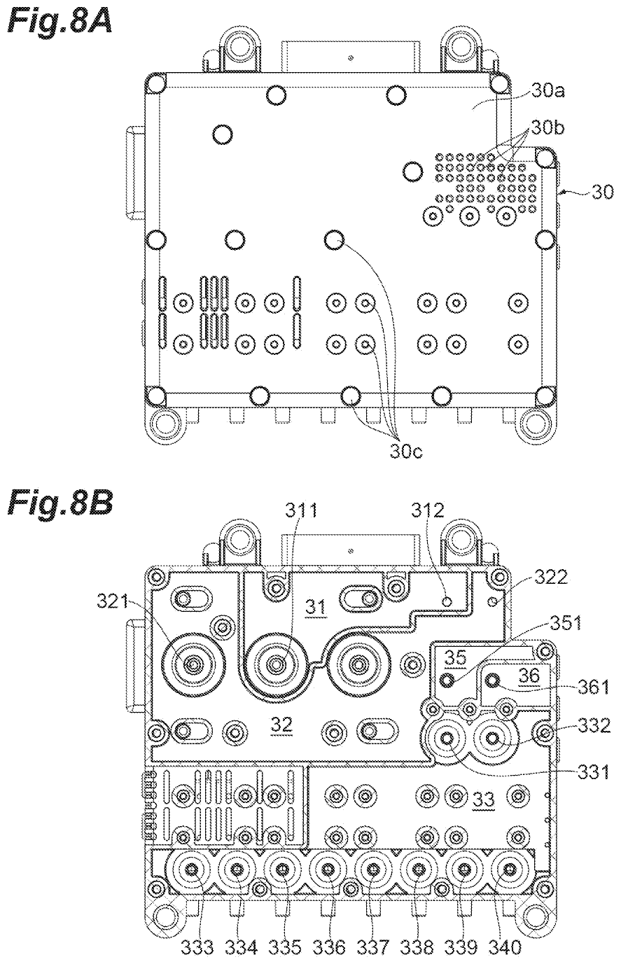

FIG. 8A is a bottom view of the air supply/exhaust system, and FIG. 8B is a schematic view in which a portion of the housing is removed from FIG. 8A. As shown in the FIG. 8A, the bottom face 30a of the housing 30 is provided with openings 30b and holes 30c. Each the openings 30b is a portion through which gas passes, and is connected to, for example, the second connection port P2 and the fourth connection port P4 of the air distribution valve unit 5. Each the holes 30c is a portion into which a fastening means such as a screw can be inserted, and may be provided with a screw groove or the like.

As shown in FIG. 8B, tanks 31 to 33 that are partitioned from each other and chambers 35 and 36 are provided in the housing 30. The tank 31 is a closed chamber portion (suction tank) to which the inlet port 4c of the air pump 4 and the first free port FP1 of the air distribution valve unit 5 are connected, and is provided with relay ports 311 and 312. The relay port 311 is a portion connected to the inlet port 4c of the air pump 4 through a tube or the like, and the relay port 312 is a portion connected to a first free port FP1 of the air distribution valve unit 5 through a tube or the like. The tank 32 is a closed chamber portion (supply tank) to which the supply port 4b of the air pump 4 and the second free port FP2 of the air distribution valve unit 5 are connected, and is provided with relay ports 321 and 322. The relay port 321 is a portion connected to the supply port 4b of the air pump 4 through a tube or the like, and the relay port 322 is a portion connected to the second free port FP2 of the air distribution valve unit 5 through a tube or the like.

The tank 33 is a closed chamber portion, which is referred to as a common tank, to which the first connection port P1 and the third connection port P3 of the air distribution valve unit 5 and each free port included in the main valve unit 6 are connected, and includes relay ports 331 to 340. The relay port 331 is a portion connected to the first connection port P1 of the air distribution valve unit 5, and the relay port 332 is a portion connected to the third connection port P3 of the air distribution valve unit 5. Each of the relay ports 333 to 340 is a portion connected to any of the free ports included in the main valve unit 6. The internal pressure of the tank 33 may be measured by a barometer or the like.

Each of the chambers 35 and 36 is an unclosed chamber connected to the outside through the openings 30b. The second connection port P2 of the air distribution valve unit 5 is connected to a relay port 351 provided in the chamber 35. The fourth connection port P4 of the air distribution valve unit 5 is connected to a relay port 361 provided in the chamber 36.

Returning to FIG. 1, the controller 7 included in the air supply/exhaust system 3 is a device that controls operations of the air pump 4, the air distribution valve unit 5, and the main valve unit 6. The controller 7 includes, for example, a central processing unit (CPU), a random access memory (RAM), and a read-only memory (ROM). The controller 7 is configured to be capable of executing a control program stored in a ROM, for example. The control program is written to operate the air pump 4, the air distribution valve unit 5, and the main valve unit 6 based on a desired sequence of expanding and decompressing the bladders 211 to 218 and 221 to 228, for example. The controller 7 may be provided in the housing 30 of the air supply/exhaust system 3 or may be provided outside the housing 30.

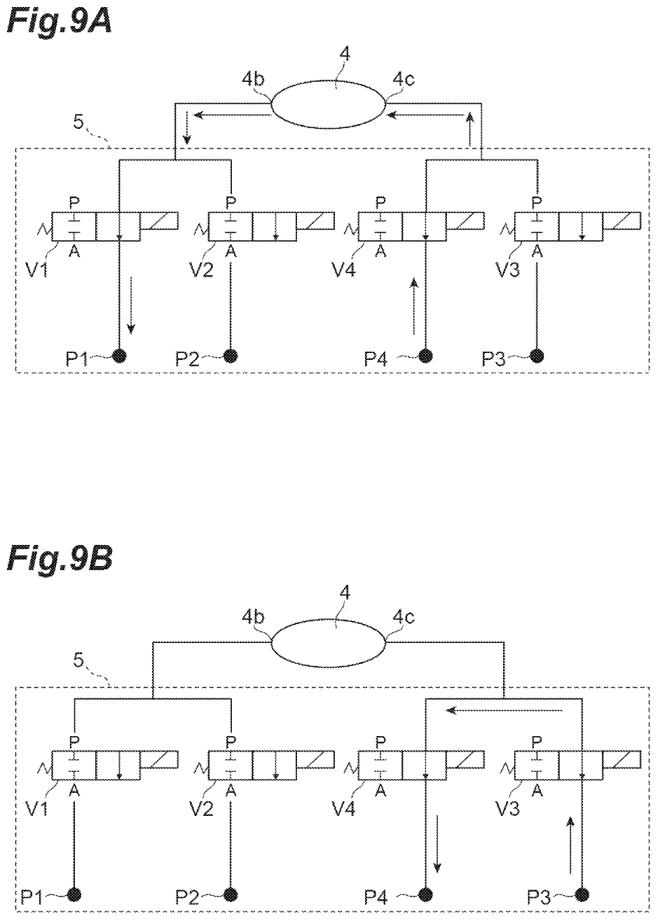

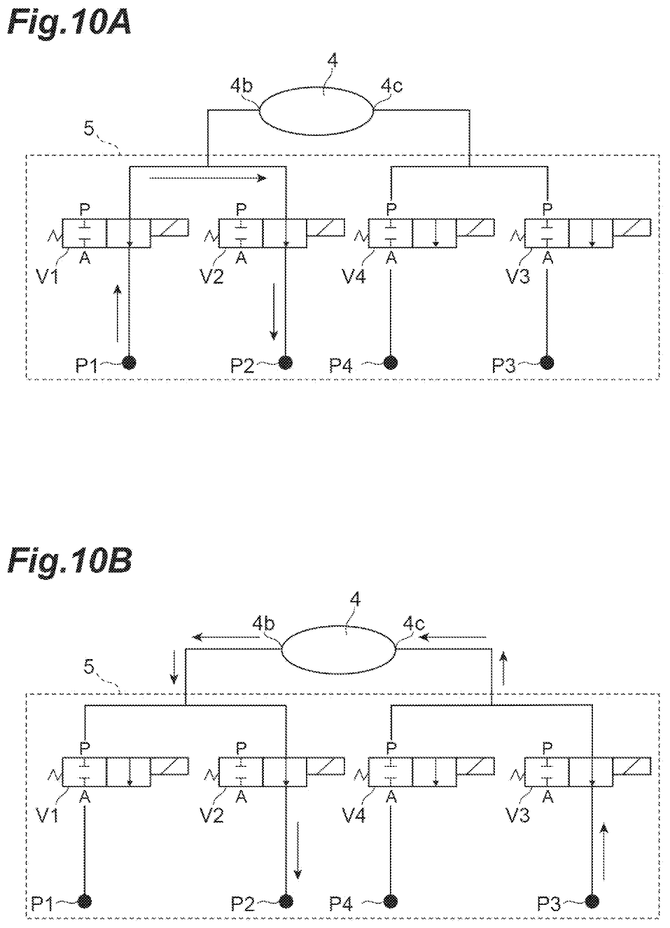

Next, the operation of the air supply/exhaust system 3 of some examples will be described with reference to FIGS. 9A and 9B and FIGS. 10A and 10B. FIGS. 9A and 9B and FIGS. 10A and 10B are circuit diagrams of an air pump and an air distribution valve unit, respectively.

First, an operation of supplying gas to the main valve unit 6 by the air supply/exhaust system 3 will be described with reference to FIG. 9A. As shown in FIG. 9A, when the air pump 4 supplies gas to the main valve unit 6, the first solenoid valve V1 and the fourth solenoid valve V4 are opened, while the second solenoid valve V2 and the third solenoid valve V3 are closed. Therefore, during the supply of gas, the first connection port P1 and the fourth connection port P4 are opened, and the second connection port P2 and the third connection port P3 are closed. Accordingly, as indicated by arrows in FIG. 9A, the gas introduced into the air pump 4 from the outside through the fourth connection port P4 is supplied to the main valve unit 6 through the first connection port P1. In some examples, during the supply of gas, the main valve unit 6 operates to supply the high-pressure gas to at least one of the bladders 211 to 218 and 221 to 228. The gas supply is carried out so that each of the bladders 211 to 218 and 221 to 228 has a desired internal pressure.

Next, an internal pressure adjustment operation by the air supply/exhaust system 3 will be described with reference to FIG. 9B. The internal pressure adjustment performed in the internal pressure adjustment operation is, for example, an adjustment of the internal pressure of at least one chamber included in the main valve unit 6, an adjustment of the internal pressure of at least one of the bladders 211 to 218 and 221 to 228, or the like. During adjustment of the internal pressure, the air pump 4 is in a suspended state. As shown in the FIG. 9B, during the adjustment of the internal pressure, the third solenoid valve V3 and the fourth solenoid valve V4 are opened, while the first solenoid valve V1 and the second solenoid valve V2 are closed. Therefore, during the adjustment of the internal pressure, the third connection port P3 and the fourth connection port P4 are opened, and the first connection port P1 and the second connection port P2 are closed. Accordingly, gas is exhausted from at least one of the chambers and/or at least one of the bladders 211 to 218 and 221 to 228 through the third connection port P3 and the fourth connection port P4 as indicated by arrows shown in the figure FIG. 9B. In some examples, during the adjustment of the internal pressure, the internal pressure of at least one of the chambers and the internal pressure of at least one of the bladders 211 to 218 and 221 to 228 may be adjusted by the operation of the main valve unit 6.

Next, a natural decompression operation by the air supply/exhaust system 3 will be described with reference to FIG. 10A. The natural decompression performed in the natural decompression operation is, for example, natural decompression of at least one chamber included in the main valve unit 6, natural decompression of the internal pressure of at least one of the bladders 211 to 218 and 221 to 228, or the like. At the time of natural decompression, the air pump 4 is suspended. As shown in FIG. 10A, during the natural decompression, the first solenoid valve V1 and the second solenoid valve V2 are opened, while the third solenoid valve V3 and the fourth solenoid valve V4 are closed. Therefore, during the natural decompression, the first connection port P1 and the second connection port P2 are opened, and the third connection port P3 and the fourth connection port P4 are closed. As a result, gas is exhausted from the chamber and the bladders 211 to 218 and 221 to 228 through the first connection port P1 and the second connection port P2 as indicated by arrows shown in FIG. 10A. In some examples, during the natural decompression, the main valve unit 6 is operated to naturally decompress each chamber and the bladders 211 to 218 and 221 to 228.

Next, the forced decompression operation by the air supply/exhaust system 3 will be described with reference to FIG. 10B. The forced decompression performed in the forced decompression operation is, for example, to forcibly decompress all the chambers included in the main valve unit 6 by gas suction of the air pump 4, or to forcibly decompress all the bladders 211 to 218 and 221 to 228 by gas suction of the air pump 4 in an emergency situation or the like. As shown in FIG. 10B, during the gas suction of the air pump 4, the second solenoid valve V2 and the third solenoid valve V3 are opened, while the first solenoid valve V1 and the fourth solenoid valve V4 are closed. Therefore, during the forced decompression, the second connection port P2 and the third connection port P3 are opened, and the first connection port P1 and the fourth connection port P4 are closed. Accordingly, as indicated by arrows in FIG. 10B, the gas introduced into the air pump 4 from the main valve unit 6 through the third connection port P3 is exhausted to the outside of the air supply/exhaust system 3 through the second connection port P2.

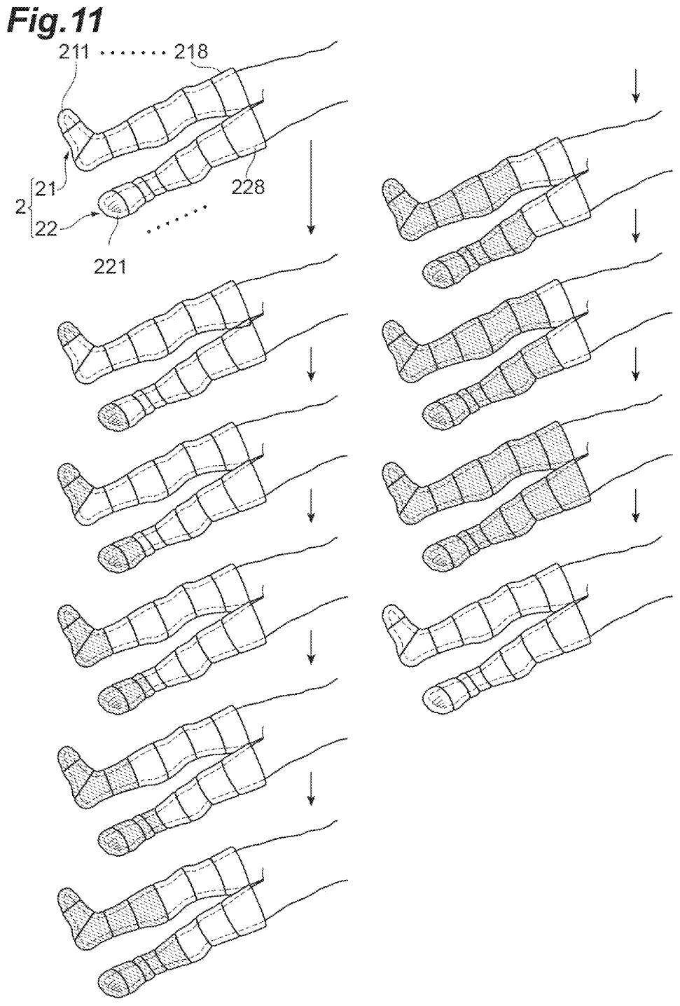

Next, the operation of the air massager 1 of some examples will be described with reference to FIG. 11. FIG. 11 is a view showing an example of a kneading pattern using a massage device. In the present disclosure, an order in which the bladders 211 to 218 and 221 to 228 are expanded or contracted by supplying high-pressure gas to the bladders 211 to 218 and 221 to 228 of the massage device 2 or exhausting high-pressure gas from the bladders 211 to 218 and 221 to 228 is referred to as a “kneading pattern.” The operation of the air massager 1 described below is merely an example.

When a massage is applied to the body in order to improve the flow of blood and/or lymph, the body may be pressed in order from the distal end portions of the four limbs toward the trunk. As a massage pattern by the massage device 2 corresponding to this, as shown in FIGS. 2 and 11, a massage pattern is conceivable in which the bladders 211 to 218 and 221 to 228 are expanded in order from the bladders 211, 221 to bladders 218, 228, respectively. At this time, the expansion of the bladders 211 to 217 and 221 to 227 is maintained until the expansion of bladder 218 and 228 is completed. In the present disclosure, the mode of the kneading pattern shown in FIG. 11 and a mode of a kneading pattern similar thereto are referred to as a “squeeze-mode.” In addition, a kneading pattern is conceivable in which the bladders 211 to 218 are sequentially expanded and the bladders 221 to 228 are sequentially expanded, the expanded bladders 211 to 218 and 221 to 228 are maintained in an expanded state (the expanded bladders 211 to 218 and 221 to 228 are temporarily held), and then the bladders 211 to 218 and 221 to 228 are contracted in the expanded order. In the present disclosure, such a mode of the kneading pattern and similar thereto are referred to as a “wave-mode.”

Japanese Patent Application No. 2020-082607 incorporated herein by reference, describes examples of operating the air supply/exhaust system 3 in the squeeze mode and in the wave mode. The controller 7 is not limited to the squeeze mode and the wave mode described above and may implement various kneading patterns by controlling the air distribution valve unit 5 and the main valve unit 6.

According to the air massager 1 including the air supply/exhaust system 3 of some examples, the main valve unit 6 is connected to both the supply port 4b and the inlet port 4c of the air pump 4 through the air distribution valve unit 5. Therefore, using the air distribution valve unit 5, the main valve unit 6 can perform both gas supply from the air pump 4 and gas suction by the air pump 4. Accordingly, by using the air supply/exhaust system 3, the internal pressure of the internal space of the main valve unit 6, the bladders 211 to 218 and 221 to 228 of the massage device 2, and the like may be more readily decompressed.

In some examples, each of the solenoid valve units 61 to 64 includes a chamber in which the first connection port P1 and the fourth connection port P4 are opened and the second connection port P2 and the third connection port P3 are closed when the air pump 4 supplies gas, the second connection port P2 and the third connection port P3 are opened and the first connection port P1 and the fourth connection port P4 are closed when the air pump 4 is suspended and the internal pressure of at least one chamber is adjusted. When the air pump 4 is suspended and each chamber is decompressed, the first connection port P1 and the second connection port P2 are opened and the third connection port P3 and the fourth connection port P4 are closed. Therefore, the air distribution valve unit 5 may be used to control various pressures in the chambers of the main valve unit 6. In addition, since a gas exhaust port in the air supply/exhaust system 3 is not limited to one of the second connection port P2 and the fourth connection port P4, deterioration of one of the first switching mechanism 51 and the second switching mechanism 52 is less likely to be accelerated.

In some examples, the first switching mechanism 51 includes the first solenoid valve V1 which is a first two way valve for controlling opening and closing of the first connection port P1 and the second solenoid valve V2 which is a second two way valve for controlling opening and closing of the second connection port P2, and the second switching mechanism 52 includes the third solenoid valve V3 which is a third two way valve for controlling opening and closing of the third connection port P3 and the fourth solenoid valve V4 which is a fourth two way valve for controlling opening and closing of the fourth connection port P4. Therefore, the structure of the air distribution valve unit 5 can be simplified.

In some examples, the air distribution valve unit 5 and each of the solenoid valve units 61 to 64 have the same configuration. In this case, since the number of common components in the air supply/exhaust system 3 is increased, cost can be reduced and maintenance can be improved.

Hereinafter, an air supply/exhaust system according to another example and an air massager including the same will be described. In the following, descriptions overlapping with those of the previously described examples may be omitted. That is, the description of the previously described features may be applied to the following examples, as appropriate.

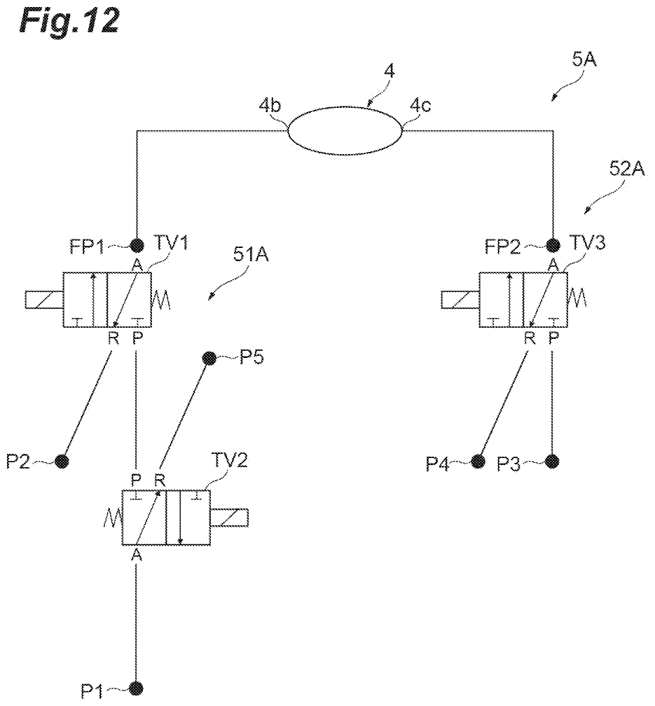

FIG. 12 is a circuit diagram of an air distribution valve unit and an air pump according to another example. As shown in FIG. 12, the second portion of the air distribution valve unit 5A includes a fifth connection port P5 connected to the outside in addition to the third connection port P5 and the fourth connection port P4. Further, the first switching mechanism 51A includes a first three way valve TV1 and a second three way valve TV2 that are connected in series to each other, and the second switching mechanism 52A includes a third three way valve TV3. The first three way valve TV1 is a solenoid valve connected to the first free port FP1, the second connection port P2, and the second three way valve TV2. The second three way valve TV2 is connected to the first connection port P1, the fifth connection port P5, and the first three way valve TV1. The third three way valve TV3 is connected to the second free port FP2, the third connection port P3, and the fourth connection port P4. Therefore, in some examples, the air distribution valve unit 5A and the solenoid valve units 61 to 64 have shapes different from each other.

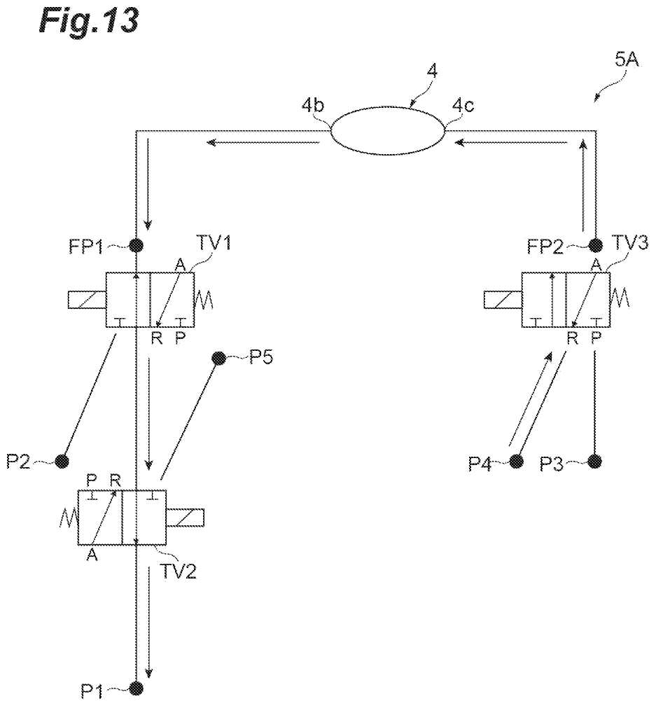

Next, the operation of the air supply/exhaust system of some examples will be described with reference to FIGS. 13 to 15. FIGS. 13 to 15 are circuit diagrams of an air pump and an air distribution valve unit, respectively.

First, a gas supply operation to the main valve unit 6 of some examples will be described with reference to FIG. 13. As shown in FIG. 13, when the air pump 4 supplies gas to the main valve unit 6, the first three way valve TV1 and the second three way valve TV2 are opened, while the third three way valve TV3 is closed. Therefore, during the supply of gas, the first connection port P1 and the fourth connection port P4 are opened, and the second connection port P2, the third connection port P3, and the fifth connection port P5 are closed. Accordingly, as indicated by arrows in FIG. 13, the gas introduced into the air pump 4 from the outside through the fourth connection port P4 is supplied to the main valve unit 6 through the first connection port P1.

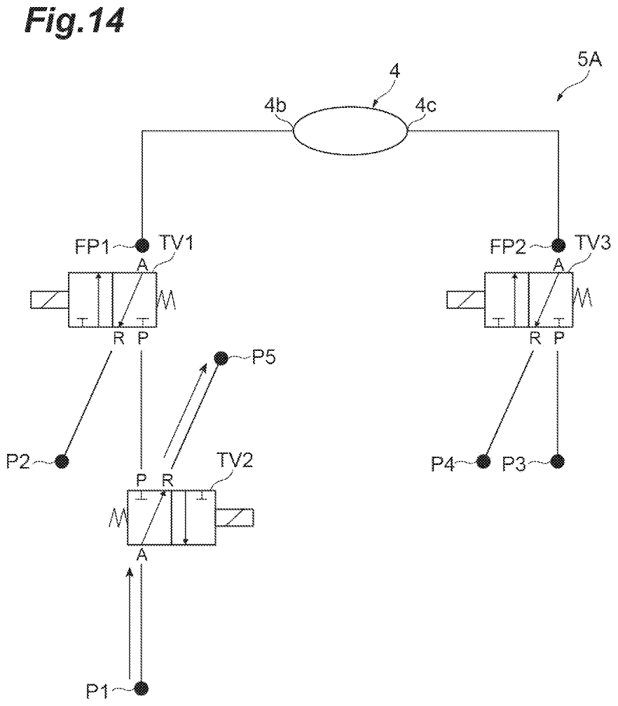

Next, the internal pressure adjusting operation and the natural decompression operation will be described with reference to FIG. 14. As shown in FIG. 14, when the internal pressure is adjusted, all of the first three way valve TV1, the second three way valve TV2, and the third three way valve TV3 are closed. Therefore, when the internal pressure is adjusted, the fifth connection port P5 is opened, and the first connection port P1 to the fourth connection port P4 are closed. Accordingly, as indicated by arrows in FIG. 14, gas is exhausted from at least one of the chambers and/or at least one of the bladders 211 to 218 and 221 to 228 through the fifth connection port P5.

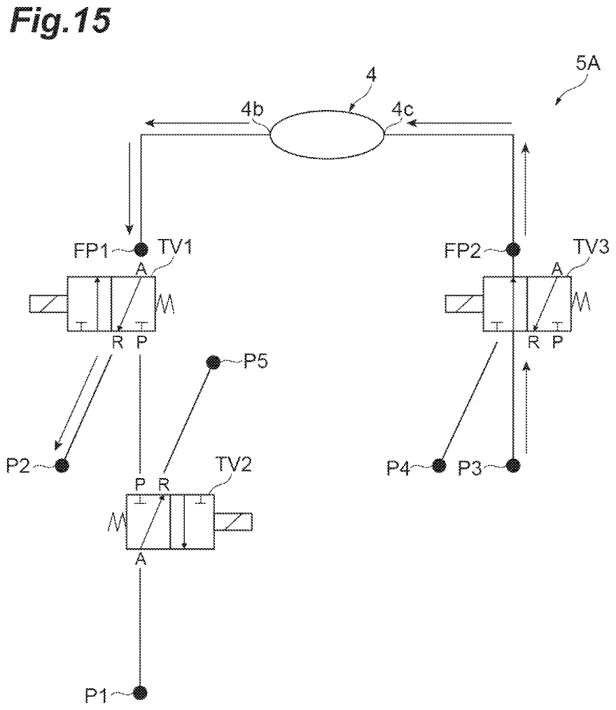

Next, the forced decompression operation will be described with reference to FIG. 15. As shown in FIG. 15, during the gas suction of the air pump 4, the third three way valve TV3 is opened, while the first three way valve TV1 and the second three way valve TV2 are closed. Therefore, during the forced decompression, the second connection port P2 and the third connection port P3 are opened, and the first connection port P1, the fourth connection port P4, and the fifth connection port P5 are closed. Accordingly, as indicated by arrows in FIG. 15, the gas introduced into the air pump 4 from the main valve unit 6 through the third connection port P3 is exhausted to the outside of the air supply/exhaust system 3 through the second connection port P2.

According to the above-described example, the number of solenoid valves included in the air distribution valve unit 5A can be reduced.

It is to be understood that not all aspects, advantages and features described herein may necessarily be achieved by, or included in, any one particular example. Indeed, having described and illustrated various examples herein, it should be apparent that other examples may be modified in arrangement and detail. For example, features of the above-described examples may be appropriately combined. For example, the air distribution valve unit may be provided with both a two way valve and a three way valve.

In addition, although the main valve unit described includes four solenoid valve units, the present disclosure is not limited thereto. The number of solenoid valve units may be determined by the number of bladders included in the massage device, for example.

Additionally, whereas each of the solenoid valve units may be connected to only one of the first massage device and the second massage device, other examples may be suitably modified in configuration. For example, each of the solenoid valve units may be connected to both the first massage device and the second massage device. In this case, some connection ports of each solenoid valve unit are connected to the first massage device, and the other connection ports are connected to the second massage device. Alternatively, a part of the solenoid valve units may be connected to only the first massage device, another part of the solenoid valve units may be connected to only the second massage device, and still another part of the solenoid valve units may be connected to both the first massage device and the second massage device.

In Additionally, whereas the two portions included in each of the solenoid valve units are connected to one of the first massage device and the second massage device, other examples may be suitably modified in configuration. For example, in each of the solenoid valve units, one portion may be connected to one of the first massage device and the second massage device, and the other portion may be connected to the other of the first massage device and the second massage device.

In some examples, the third connection port and the fourth connection port are opened during the internal pressure adjustment, however the present disclosure is not limited thereto. For example, the first connection port and the second connection port may be opened during the internal pressure adjustment. In this case, the third connection port and the fourth connection port may be opened during natural decompression. During the natural decompression, the first connection port, the second connection port, the third connection port, and the fourth connection port may be opened. In this case, the time required for decompression can be shortened.

In addition, although the air distribution valve unit and the solenoid valve unit have the same shape in some examples, they may have different shapes in other examples.

What is claimed is:

1. An air pump system for an air massager, comprising:
an air pump including an inlet port and a supply port;
a main valve device including solenoid valve devices; and
an air distribution valve device connected between the air pump and the main valve device, wherein the air distribution valve device includes:
a first portion including a first free port connected to the supply port of the air pump, a first connection port connected to the main valve device, a second connection port connected to an outside of the air distribution valve device, and a first switch configured to control opening and closing the first connection port, and opening and closing the second connection port; and
a second portion including a second free port connected to the inlet port of the air pump, a third connection port connected to the main valve device, a fourth connection port connected to the outside of the air distribution valve device, and a second switch configured to control opening and closing the third connection port, and opening and closing the fourth connection port.

2. The air pump system according to claim 1,
wherein each of the solenoid valve devices includes a first portion forming a first chamber that is fluidly coupled to a first free port, a first connection port and a second connection port in the first portion, and a second portion forming a second chamber that is fluidly coupled to a second free port, a third connection port and a fourth connection port in the second portion, and
wherein a first switch of the first portion and a second switch of the second portion in the solenoid valve device, are configured to:
open the first connection port and the fourth connection port, and close the second connection port and the third connection port, in response to a supply of gas from the air pump;
open the second connection port and the third connection port, and close the first connection port and the fourth connection port, in response to a drawing of gas by the air pump;
open the third connection port and the fourth connection port, and close the first connection port and the second connection port, in response to a suspended state of the air pump and to an adjustment of an internal pressure in one or both of the first chamber and the second chamber; and
open the first connection port and the second connection port, and close the third connection port and the fourth connection port, in response to a suspended state of the air pump and to a decompression of the first chamber and of the second chamber.

3. The air pump system according to claim 1,
wherein the first switch includes a first two-way valve configured to control opening and closing the first connection port and a second two-way valve configured to control opening and closing the second connection port, and
wherein the second switch includes a third two-way valve configured to control opening and closing the third connection port and a fourth two-way valve configured to control opening and closing the fourth connection port.

4. The air pump system according to claim 1, wherein each of the solenoid valve devices has a same configuration as the air distribution valve device.

5. The air pump system according to claim 1,
wherein the second portion further includes a fifth connection port connected to the outside of the air distribution valve device,
wherein the first switch includes a first three-way valve and a second three-way valve connected in series to each other,
wherein the first three-way valve is configured to control opening and closing the first free port, the second connection port, and the second three-way valve,
wherein the second three-way valve is configured to control opening and closing the first connection port, the fifth connection port, and the first three-way valve, and
wherein the second switch includes a third three-way valve configured to control opening and closing the second free port, the third connection port and the fourth connection port.

6. The air pump system according to claim 5,
wherein each of the solenoid valve devices of the main valve device includes a first portion forming a first chamber that is fluidly coupled to a first free port, a first connection port and a second connection port of the solenoid valve device, and a second portion forming a second chamber that is fluidly coupled to a second free port, a third connection port, a fourth connection port and a fifth connection port of the solenoid valve device, and
wherein a first switch of the first portion and a second switch of the second portion in the solenoid valve device, are configured to:
open the first connection port and the fourth connection port, and close the second connection port, the third connection port, and the fifth connection port, in response to a supply of gas from the air pump;
open the second connection port and the third connection port, and close the first connection port, the fourth connection port, and the fifth connection port, in response to a drawing of gas by the air pump; and
open the fifth connection port, and close the first connection port, the second connection port, the third connection port and the fourth connection port, in response to a suspended state of the air pump and to an adjustment of an internal pressure in one or both of the first chamber and the second chamber.

7. An air massager comprising:
the air pump system according to claim 1; and
a massage device connected to the main valve device.

8. An air pump system comprising:
a pump including a suction port and a supply port for a gas;
a main valve device to transfer the gas to an inflatable device; and
a distribution valve device connected between the pump and the main valve device, wherein the distribution valve device includes:
a first portion forming a first chamber, wherein the first portion includes a first free port to fluidly couple the first chamber with the supply port of the pump, a first connection port to fluidly couple the first chamber with the main valve device, a second connection port to fluidly couple the first chamber with an environing air outside the distribution valve device, and a first valve switch configured to selectively open or close the first connection port and to selectively open or close the second connection port; and
a second portion forming a second chamber, wherein the second portion includes a second free port to fluidly couple the second chamber with the suction port of the pump, a third connection port to fluidly couple the second chamber with the main valve device, a fourth connection port to fluidly couple the second chamber with the environing air, and a second valve switch configured to selectively open or close the third connection port and to selectively open or close the fourth connection port.

9. The air pump system according to claim 8,
wherein the main valve device includes a plurality of modular devices, and
wherein each of the modular devices of the main valve device has a configuration identical to the distribution valve device.

10. The air pump system according to claim 8,
wherein the main valve device includes a plurality of modular devices,
wherein the modular devices of the main valve device have an identical configuration, and
wherein each of the modular devices includes:
a first portion forming a first chamber, wherein the first portion includes: a first free port to fluidly couple the first chamber with the first connection port of the distribution valve device; a first connection port to fluidly couple the first chamber with the inflatable device; a second connection port to fluidly couple the first chamber with the inflatable device; and a first valve switch to selectively open or close the first connection port and to selectively open or close the second connection port; and
a second portion forming a second chamber, wherein the second portion includes: a second free port to fluidly couple the second chamber with the second connection port of the distribution valve device; a third connection port to fluidly couple the second chamber with the inflatable device; a fourth connection port to fluidly couple the second chamber with the inflatable device; and a second valve switch to selectively open or close the third connection port and to selectively open or close the fourth connection port.

11. The air pump system according to claim 8, further comprising a controller configured to operate the first valve switch and the second valve switch in order to:
open the first connection port and the fourth connection port, and close the second connection port and the third connection port, in response to a supply of gas from the air pump;
open the second connection port and the third connection port, and close the first connection port and the fourth connection port, in response to a drawing of gas by the air pump;
open the third connection port and the fourth connection port, and close the first connection port and the second connection port, in response to a suspended state of the air pump and to an adjustment of an internal pressure in one or both of the first chamber and the second chamber; and
open the first connection port and the second connection port, and close the third connection port and the fourth connection port, in response to a suspended state of the air pump and to a decompression of the first chamber and of the second chamber.

12. The air pump system according to claim 8,
wherein the first switch includes a first two-way valve configured to selectively open or close the first connection port, and a second two-way valve configured to selectively open or close the second connection port, and
wherein the second switch includes a third two-way valve configured to selectively open or close the third connection port, and a fourth two-way valve configured to selectively open or close the fourth connection port.

13. The air pump system according to claim 8,
wherein the second portion further includes a fifth connection port to fluidly couple the second chamber with the environing air,
wherein the first switch includes a first three-way valve and a second three-way valve connected in series to each other,
wherein the first three-way valve is configured to selectively open or close the first free port, the second connection port, and the second three-way valve,
wherein the second three-way valve is configured to selectively open or close the first connection port, the fifth connection port, and the first three-way valve, and
wherein the second switch includes a third three-way valve configured to selectively open or close the second free port, the third connection port and the fourth connection port.

14. The air pump system according to claim 13, further comprising a controller configured to operate the first valve switch and the second valve switch in order to:
open the first connection port and the fourth connection port, and close the second connection port, the third connection port, and the fifth connection port, in response to a supply of gas from the air pump;
open the second connection port and the third connection port, and close the first connection port, the fourth connection port, and the fifth connection port, in response to a drawing of gas by the air pump; and
open the fifth connection port, and close the first connection port, the second connection port, the third connection port and the fourth connection port, in response to a suspended state of the air pump and to an adjustment of an internal pressure in one or both of the first chamber and the second chamber.

15. A modular device for an air pump system, comprising:
a first portion forming a first chamber, wherein the first portion includes a first free port to fluidly couple the first chamber with a gas supply device, a first connection port to fluidly couple the first chamber with a gas consumption device, a second connection port to fluidly couple the first chamber with an environing air outside the modular device, and a first valve switch configured to selectively open or close the first connection port and selectively open or close the second connection port; and
a second portion forming a second chamber, wherein the second portion includes a second free port to fluidly couple the second chamber with the gas supply device, a third connection port to fluidly couple the second chamber with the gas consumption device, a fourth connection port to fluidly couple the second chamber with the environing air, a second valve switch configured to selectively open or close the third connection port and selectively open or close the fourth connection port.

16. The modular device according to claim 15, wherein the modular device is configured to form a distribution valve device that is coupled between a pump as the gas supply device, and a main valve device as the gas consumption device to supply an inflatable device.

17. The modular device according to claim 15,
wherein the modular device is configured to form a main valve device that is coupled between a distribution valve device as the gas supply device and an inflatable device as the gas consumption device, and
wherein the modular device is configured to operate four airbags of the inflatable device via the first connection port, the second connection port, the third connection port and the fourth connection port, respectively.

18. A main valve device to operate an inflatable device, comprising a plurality of modular devices including the modular device according to claim 17,
wherein the first connection port, the second connection port, the third connection port and the fourth connection port of each of the modular devices are configured to be fluidly coupled to the inflatable device.

19. The main valve device according to claim 18,
wherein the main valve device is further configured to be coupled between a distribution valve device and the inflatable device, and
wherein the first free port and the second free port of each of the modular devices are configured to be fluidly coupled to the distribution device.

20. The main valve device according to claim 18, wherein the plurality of modular devices have an identical structure.
